(19) United States
(12) Patent Application Publication
(10) Pub. No.: US 2009/0229230 A1
(43) Pub. Date: Sep. 17, 2009

(54) AUTOMATIC DUST DEBRIS CLEARING APPARATUS FOR A FILTER DRUM IN A DUST COLLECTOR

(75) Inventor: Mao-Nan Cheng, Taichung County (TW)

Correspondence Address: PAI PATENT & TRADEMARK LAW FIRM, 1001 FOURTH AVENUE, SUITE 3200, SEATTLE, WA, 98154, US

(73) Assignee: SAN FORD MACHINERY CO., LTD., Taichung County (TW)

(21) Appl. No.: 12/046,438

(22) Filed: Mar. 11, 2008

(51) Int. Cl. B01D 46/04

(52) U.S. Cl. 55/297

(57) ABSTRACT

An automatic dust debris clearing apparatus for a filter drum in a dust collector mainly comprises a guidance support. At least two dust clearing elements are provided at a side of the guidance support and arranged at an equal interval of distance, each of the dust clearing elements being provided with a mount on which much brush may exactly be arranged in each of the grooves on the walls of filterable paper in the filter drum. A drive element is provided with a barometric vat of which one end is pivoted to the central guide rod, and thus the barometric vat functions in the principle of lever to drive the dust clearing elements to turn synchronously, thereby full automatically scraping the dust debris on the filterable paper for achievement of stable operation, scrape with the even force, and long service life of filter drum.

### BACKGROUND OF THE INVENTION

1. Field of the Invention

This invention relates to a dust debris clearing apparatus and particularly to an automatic dust debris clearing apparatus for a filter drum in a dust collector.

2. Description of Related Art

What is shown in FIG. 1 is a conventional dust collector. The dust collector 10 comprises a pedestal 11 on which an air blower 12 and a dust collection stand 13 are provided, in which the dust collection stand 13 is connected to the air blower 12 through an air duct 14; further, a bottom end of the dust collection stand 13 is covered with a dust collection bag 15 and a top end is covered with a well ventilated filter drum 16. When the air blower 12 runs, a pipeline connected to the air blower 12 is made to generate a vacuum suction that sucks the dust debris into the air blower 12, and then the dust debris fall into the lower dust collection bag 15 sequentially through the air duct 14 and the dust collection stand 13 for collection. The filter drum 16 set above the dust collection stand 13 is used to mainly exhaust in the process of dust collection, so the quantity and smooth of air displacement is vitally related to the performance of dust collection.

Refer to FIG. 2 as a sectional view illustrating the filter drum 16 used for increasing the performance of exhaust. The filter drum 16 is structured with a filterable paper 162 provided in a cylindrical outer frame 161. The filter paper 162 is formed into several jagged and curved wall fringes arranged perpendicularly, and encircles a surrounding wall inside the filter drum 16 so that the fold filter drum 16 with a plurality of vertical coned grooves 163 are formed in the inner wall of the filter drum 10 and a surface area of the filter drum 16 that contacts the outside is made to increase for heightening the quantity of exhaust. Generally, a ventilation hole of the filterable paper is small so that small dust debris may also be prevented from being vented out of the ventilation hole for the performance of dust collection. However, after the function of vacuum suction is used for a period of time, the coned groove 163 of the filterable paper 162 is constantly stained with very small dust and particles and thus blocked, thereby being necessarily cleaned regularly. No dust debris clearing apparatus is provided in the filter drum 16, so the filter drum 16 must be fully taken apart and an air blow gun or a brush is used to clean out the filter drum.

In consideration of the defects above, an apparatus clearing the dust debris in the filter drum that is provided in this invention, as shown in FIG. 3, is provided with a clearing device 20 axially pivoted in the filter drum 16. The clearing device 20 mainly comprises a guidance support 21 on which a brush base 22 is provided, and a large deal of brush 23 is distributed around the outside of brush base 22 and may exactly be arranged in each of the curved grooves 163. A traction unit 24 is provided on an outer frame 161 of the filter drum 16 and provided with several pulley stands 241 above which a traction rope 242 is wound, and handles 25 are connectively provided above two sections of the traction rope 242 outside the filter drum 16. The two sections of traction rope 242 link to the brush base 22, and the handles 25 may be manually pulled downwards in turn to affect the brush base 22 to slip upwards or downwards so that the bush 23 may vertically scrape to clear the dust on the inner walls of each of the curved grooves 163, thereby being apparent that the dust in the filter drum 16 that is not necessarily taken apart may be easily cleared even.

The clearing device used for the filter drum 16 may manually not only affect the brush base 22 to slip upwards and downwards, but also turn the guidance support 21. However, if the brush base 22 is manually affected with an uneven force and unstable operation, it is poor to clear the dust in part of the filter drum 16; further, if it is affected with an excessive force, because the brush 23 contacts and rubs against the filterable paper 162, the filterable paper 162 is damaged and thus the service life of filter drum 16 is shortened. An effective solution to the issue mentioned above is necessary for the better effect of clearing of the dust in the filter drum 16.

Consequently, because of the technical defects of described above, the applicant keeps on carving unflaggingly through wholehearted experience and research to develop the present invention, which can effectively improve the defects described above.

### SUMMARY OF THE INVENTION

An automatic dust debris clearing apparatus for a filter drum in a dust collector is provided in this invention. A guidance support is provided in the center of filter drum. At least two dust clearing elements are provided at a side of the guidance support. The dust clearing elements are arranged at an equal interval of distance, in which each of the dust clearing elements is provided with a vertically arranged mount on which a large deal of brush is formed, and a drive element is provided at the top edge of the outside of filter drum. The drive element is mainly provided with a barometric vat provided with a function rod of which one end is pivoted to a drive connecting rod that is bent at a predetermined angle, and the other end is pivoted to a top end of a guide rod; the barometric vat is used to inlet and outlet air and the drive connecting rod is used in the principle of lever to drive the dust clearing elements to turn synchronously, thereby full automatically scraping the dust debris on the filterable paper for achievement of stable operation, scrape with the even force, and long service life of filter drum.

### BRIEF DESCRIPTION OF THE DRAWINGS

FIG. 1 is a view of the appearance of a conventional dust collection machine;

FIG. 2 is a sectional view of a conventional filter drum;

FIG. 3 is a 3D sectional view of a conventional partial dust debris clearing apparatus for a filter drum;

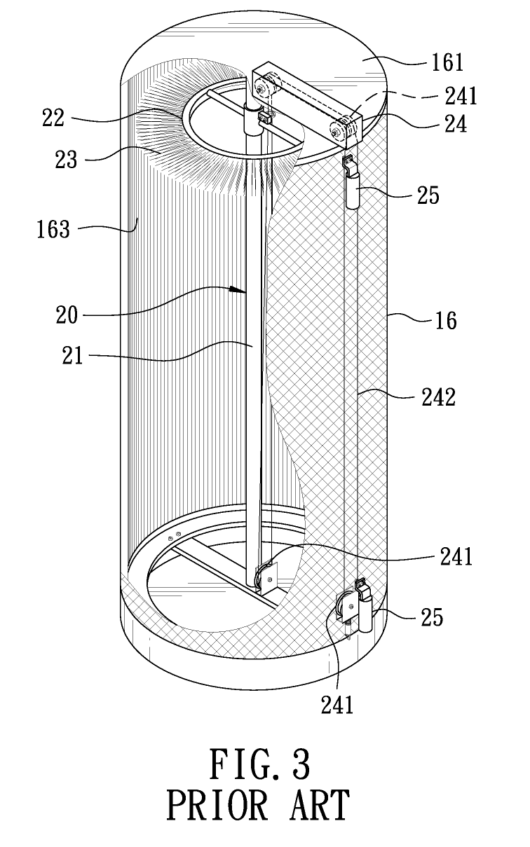

FIG. 4 is a schematic 3D view illustrating a preferred embodiment of this invention;

FIG. 5 is a partial 3D view of the preferred embodiment of this invention;

FIG. 6 is a bottom view of the preferred embodiment of this invention;

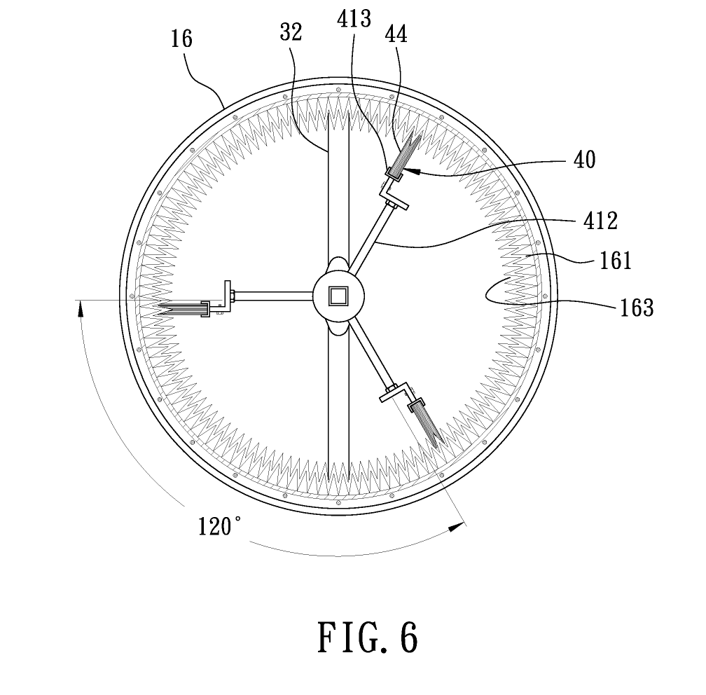

FIG. 7 is a sectional assembly view of the preferred embodiment of this invention;

FIG. 8 is a view of the appearance of the apparatus in the preferred embodiment of this invention;

FIG. 9 is a partial sectional 3D view of another embodiment of this invention; and

FIG. 10 is a 3D view of dust clearing elements in a further embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

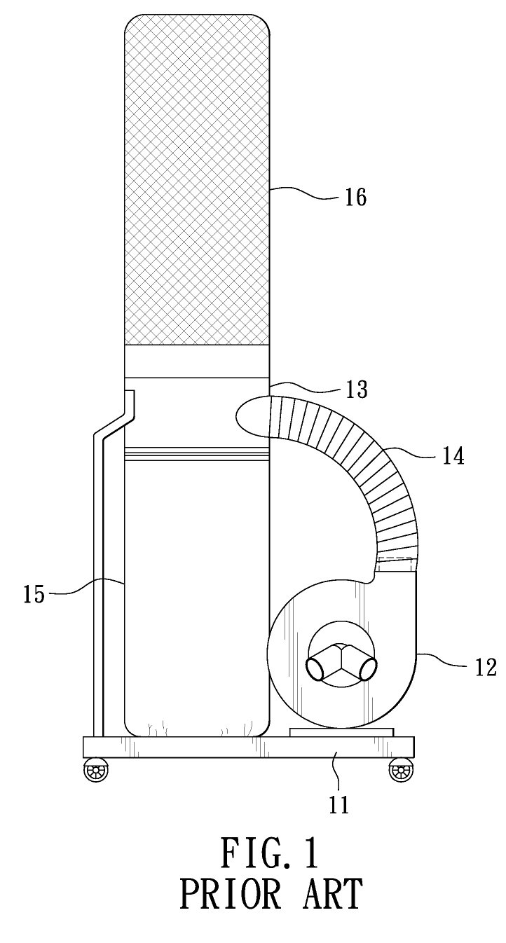

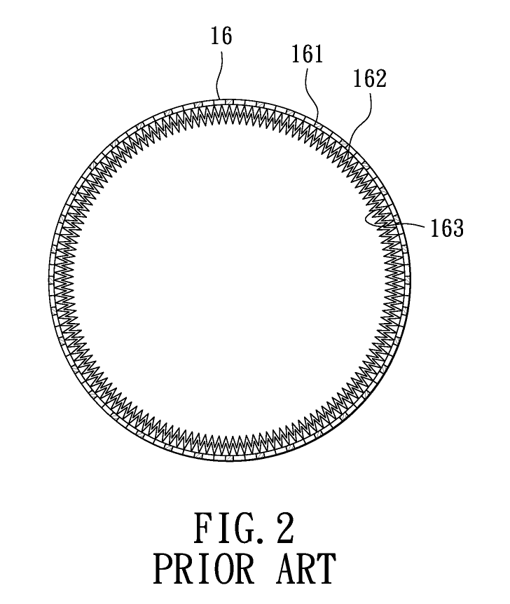

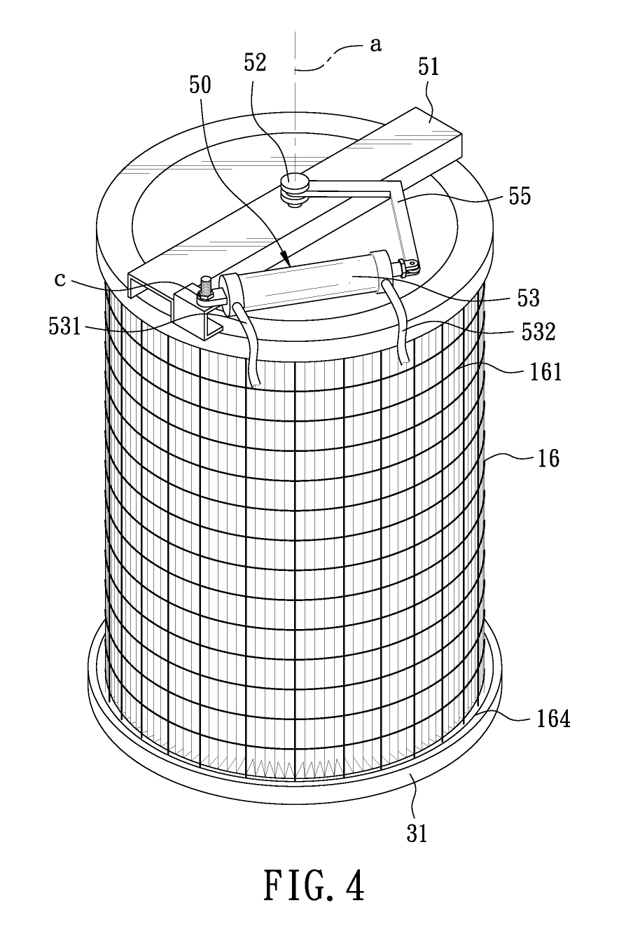

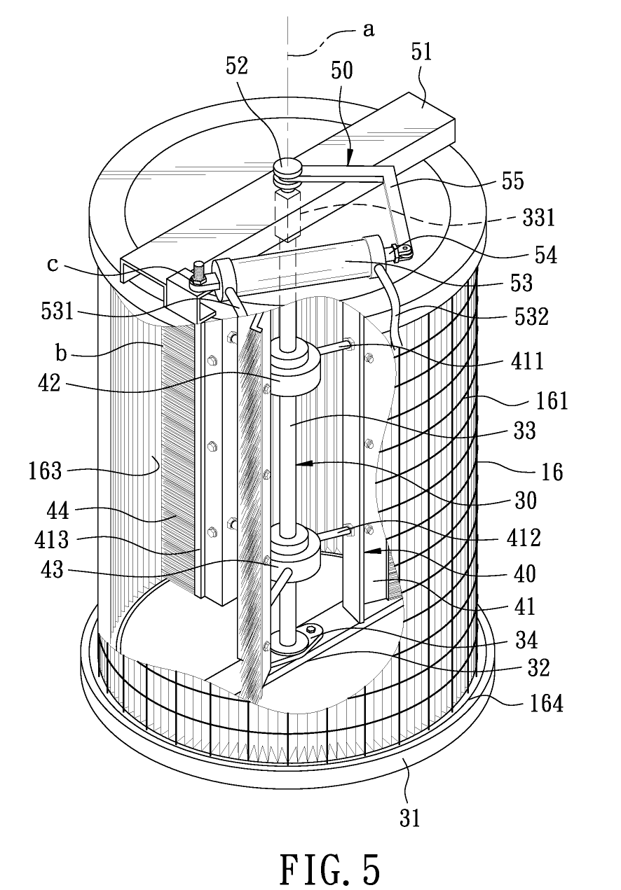

Refer to FIGS. 4 and 5 respectively as a semblance view and a partial sectional 3D view that illustrate an automatic dust debris clearing apparatus for a filter drum in a dust collection machine. The filter drum according to this invention is the same as that described above, of which reference numbers follow those in FIGS. 1 and 2. A joint seat 164 is provided to join the bottom of an outer frame 161 of the filter drum 16, allowing the clearing apparatus to be axially arranged in the filter drum 16. The clearing apparatus comprises a guidance support 30, 3 dust clearing elements 40, and a drive element 50.

The guidance support 30 mainly comprises an annular base 31 combined with the bottom of joint seat 164, in which a bottom support 32 is provided transversally across the base 31 and on which a central guide rod 33 is pivoted axially toward the inside of filter drum 16. The central guide rod 33 lies on a central axis a of the filter drum 16 and is fixed onto the bottom support 32 with a stationary joint pedestal 34, and a top end of the central guide rod 33 is a quadrangular sleeve 331 joint to a top wall of the filter drum 16.

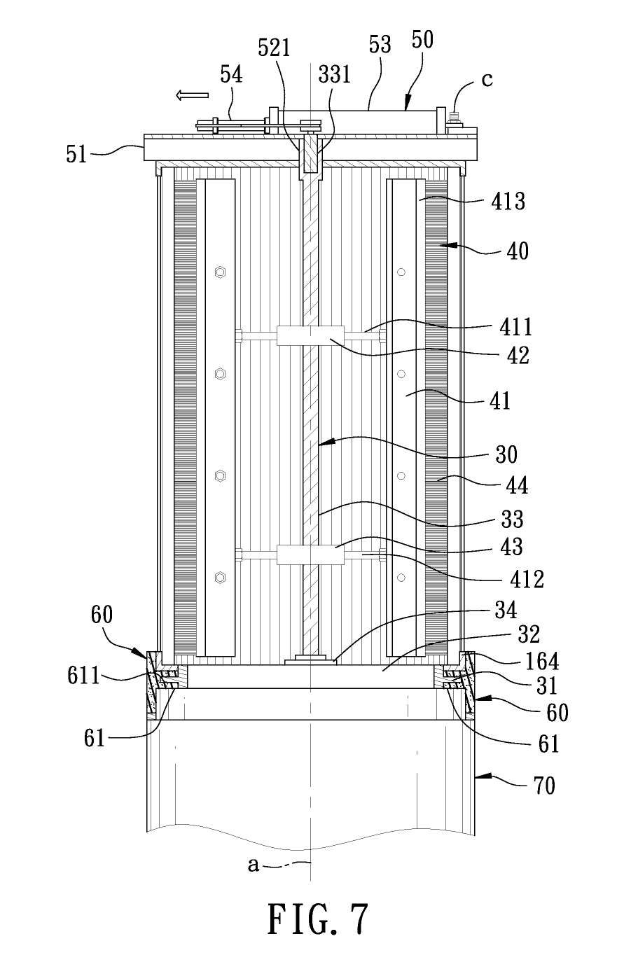

Each of the 3 dust clearing elements 40 is provided at a side of the central guide rod 33 between the central axis a and the filterable paper 162. The dust clearing elements are arranged at an equal interval of distance. In the embodiment, the dust clearing elements 40 are adjacent to each other at the angle of 120, in which each of the dust clearing elements 40 is provided with an L-shaped fixing base 41 formed into a rectangular plate that is transversally arranged. Transversal connecting rods 411 and 412 are separately fixed at an adequate distance to upper and lower ends of the fixing base 41. Further, with round sheaths 42 and 43, each of the connecting rods 411 and 412 of the dust clearing elements 40 stretches transversally and joints the upper and lower ends of the central guide rod 33. A slot 413 is formed at the buckling front side of the fixing base 41 for a large deal of brush 44 to be transversally inserted. Refer to FIG. 7 as a sectional view illustrating the preferred embodiment of this invention. The brush 44 may be dismantled for displacement, of which the front end may exactly get into each of the curved grooves 163 and is kept from each of the curved grooves 163 with a gap b to reduce the frictional resistance to the dust clearing elements 40 that scrape in the curved grooves 163.

With reference to FIGS. 5 and 7, the top element 50 is provided at the top of the outside of filter drum 16 and connected to one end of the dust clearing element 40. The drive element 50 is provided with a fixed plate 51 across the top of filter drum 16, and an axial rod 52 is provided in the center of fixed plate 51 that is corresponding to the central guide rod 33. The axial rod 52 passes through the filter drum 16 inside which a quadrangular rod 521 is provided to joint to the quadrangular sleeve 331 at the top of central guide rod 33. A transversally arranged barometric vat 53 is provided adjacent to a right side of the fixed plate 51. One end of the barometric vat 53 is fixed to one side of the fixed plate 51, thereby a pivot point c being formed. A function rod 54 is axially provided in the barometric vat 53. The function rod 54 may function to axially forwards stretch out and return through an air inlet 531 and an air outlet 532 at two ends of the barometric vat 53. Meanwhile, the barometric vat 53 shifts toward the fixed plate 51 along the pivot point c. A front end of the function rod 54 is pivoted to a drive connecting rod 55 that is bent inwards at the angle of approximately 90, and the other end of the drive connecting rod 55 is pivoted to the top end of axial rod 52.

In order to further make apparent the structural features, applied skill and manners, and expected effects according to this invention, what are applied in this invention are in detail described, and it is thus believed that this invention is thoroughly and concretely apparent, as described below.

When the dust collection machine is assembled, firstly, the dust clearing elements 40 are installed on the central guide rod 33 and placed from the bottom of filter drum 16 through the central guide rod 33 so that the quadrangular sleeve 331 at the top end may be put around the drive element 50 to pass through the quadrangular rod 521 at the top end of filter drum 16, and the base 31 is arranged against the bottom of joint seat 164 at the bottom of outer frame 161. The bottom of base 31 joints a flexible rubber ringed seat 60 made of a rubber, in which a fixing portion 61 annularly protrudes in the center of the inner wall of rubber ringed seat 60, and a wedge slot 611 is concave annularly in the center of the fixing portion 61 to separate the rubber ringed seat 60 provided with an upper space and a lower space. The upper space may be wedged to the bottom of outer frame 161 of the filter drum 16, the wedge slot 611 may be put around the base 31, and the lower space may be put around a dust collection barrel 70. With the flexible rubber ringed seat 60, the dust collection machine may be well assembled and stable.

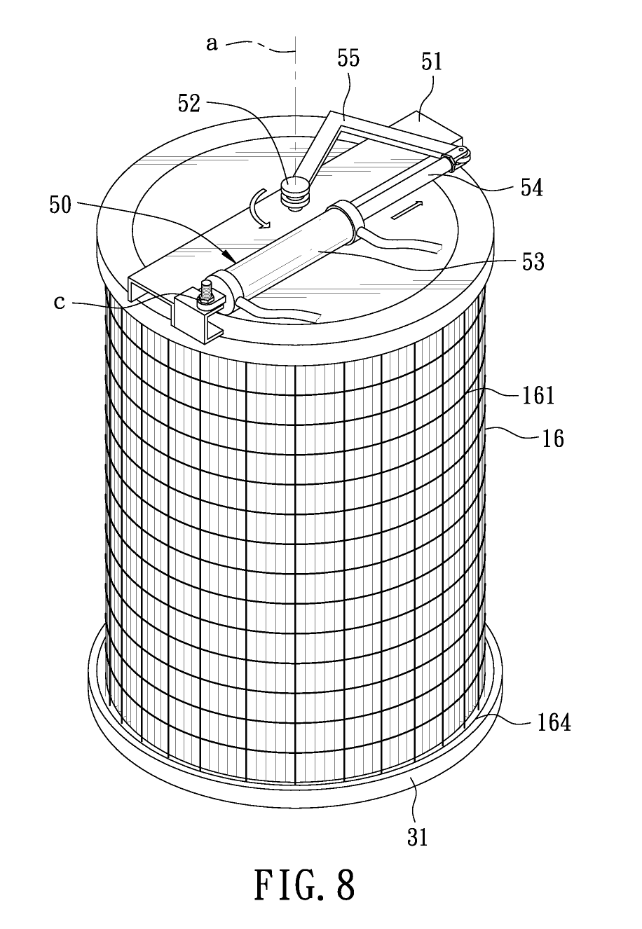

With reference to FIG. 4 and cross reference to FIGS. 7 and 8 respectively as a state view and a semblance view that illustrate the service of apparatus in the preferred embodiment of this invention, when the dust collection machine is enabled, the function rod 54 in the barometric vat 53, through the air inlet and outlet 531 and 532, axially stretches forward. Meanwhile, the barometric vat 53 shifts toward the fixed plate 51, and the function rod 54 drives the drive connecting rod 55 to transversally shift toward a left side of the fixed plate 51 for driving the central guide rod 33 to pivot back and forth at an adequate angle. When the function rod 54 returns, the drive connecting rod 55 returns. Thus, with the function rod 54 of barometric vat 53 that shifts back and forth and in the principle of lever, the dust clearing elements 40 are driven to synchronously shift back and forth, thereby full automatically scraping the dust on the filterable paper 162. Further, the brush 44 of the dust clearing elements 40 may transversally scrape to clear the dust on the inner wall of each of the curved grooves 163, and the count of air inlet to the barometric vat 53 may be set to control the number of times of dust clearing.

After the dust clearing elements 40 are used for a period of time, the front end of the brush 44 on the elements 40 is easily damaged and dirty because the brush 44 contacts and causes friction with the filterable paper 162. When the brush 44 is replaced, the dust collection barrel 70 set onto the bottom of rubber ringed seat 60 is firstly removed and then the rubber ringed seat 60 may be pulled out from the base 31. At this time, the central guide rod 33 set onto the quadrangular rod 521 may be fully removed to replace the brush of dust clearing element 40. Afterwards, the central guide rod 33 is again installed in the filter drum 16.

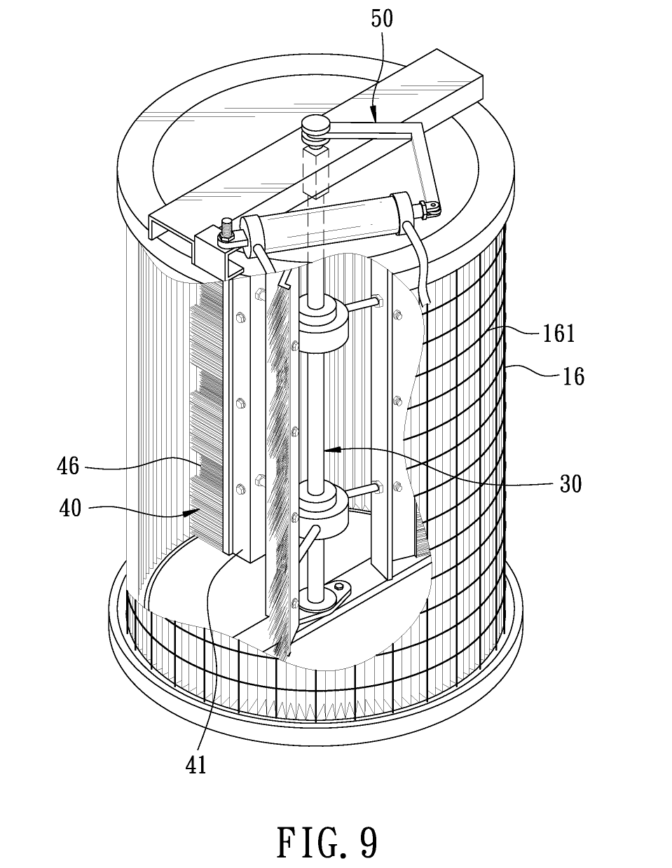

Refer to FIG. 9 illustrating another preferred embodiment of this invention. The structure and function in the preferred embodiment is the same as that in the previous embodiment, so unnecessary details are not given here, and what is different is that parts of the brush 44 on the fixing base 41 of each of the dust clearing elements 40 stretches to the inside of each of the curved grooves 163, parts of brush 44 stretch to the top of each of the curved grooves 163, and the brush 44 is inserted into and crosses on each of the grooves 413 to reduce the frictional resistance caused by the dust clearing element 40 scraping each of the curved grooves 163 so that the drive element 50 may drive the dust clearing elements 40 to shift with less energy.

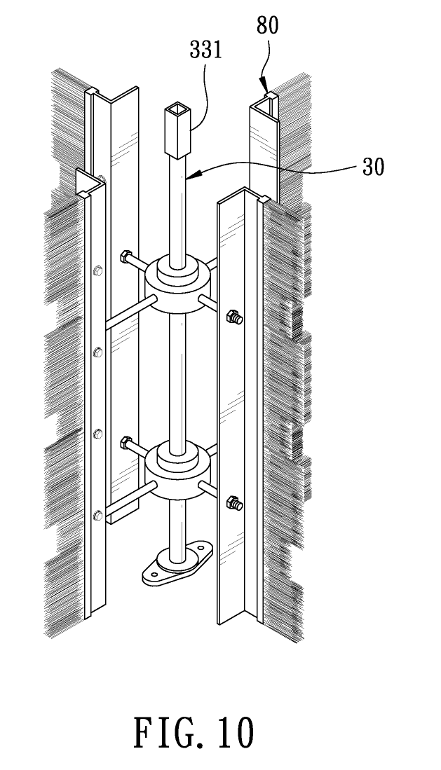

Refer to FIG. 10 as a 3D view illustrating the dust clearing elements in a further embodiment of this invention. The structure and function in the preferred embodiment is the same as that in the previous embodiment, so unnecessary details are not given here, and what is different is that 4 dust clearing elements 80 are arranged around central guide rod 33. The dust clearing elements 80 are adjacent to each other at the angle of 90, in which the adjacent angle of each couple of dust clearing elements 80 is smaller than a setting angle of the dust clearing element 40 in the preferred embodiment of this invention. Thus, the drive element 50 drives the 4 dust clearing elements 40 to turn at a short distance, thereby less power of energy being consumed. Here, the features and attainable expected effects of this invention are described again below:
1. In this invention, the barometric vat is used to inlet and outlet air and the drive connecting rod is used in the principle of lever to drive the dust clearing elements to turn synchronously, thereby full automatically scraping the dust debris on the filterable paper for achievement of stable operation, scrape with the even force, long service life of filter drum, and equipment cost down.
2. Many groups of dust clearing elements according to this invention may be provided, the quadrangular sleeve at the top of guidance support is used to put around the quadrangular rod of drive element, and the base is fixed with the rubber ringed seat, thereby the assembly being finished; before the brush of dust clearing element is dismantled for displacement, the quadrangular rod may be removed from the guidance support for easy removal and installation.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An automatic dust debris clearing apparatus for a filter drum in a dust collector, the filter drum being structured with a filterable paper provided in a cylindrical outer frame of which the bottom end is formed with a joint seat, the filterable paper being formed into several jagged and curved wall fringes arranged perpendicularly so that a plurality of coned grooves that are curved are formed on the inner wall of filter drum, the clearing apparatus being axially provided in the filter drum, comprising:
a guidance support mainly comprising an annular base combined with the bottom of joint seat, in which a bottom support is provided transversally across the base, on which a central guide rod is pivoted axially toward the inside of filter drum, the top end of central guide rod being combined with the top wall of filter drum;
at least 2 dust clearing elements respectively provided at a predetermined position of the side of central guide rod, the dust clearing elements being arranged at an equal interval of distance, in which each of the dust clearing elements is provided with a vertically arranged mount on which a large deal of brush is formed, the brush exactly stretching to each of the curved grooves;
a drive element provided at the top of the outside of filter drum and connected to a top end of the guidance support, the drive element mainly comprising a barometric vat provided with a function rod of which one end is pivoted to a drive connecting rod that is bent at a predetermined angle, and the other end is pivoted to a top end of a central guide rod so that when the barometric vat drives the function rod to inlet and outlet air, the central guide rod is driven to pivot back and forth at a predetermined angle to make the dust clearing elements move to synchronously scrape the dust debris from the filterable paper.

2. The automatic dust debris clearing apparatus for the filter drum in the dust collector according to claim 1, wherein 3 dust clearing elements are arranged around the central guide rod and adjacent to each other at the angle of 120.

3. The automatic dust debris clearing apparatus for the filter drum in the dust collector according to claim 1, wherein 4 dust clearing elements are arranged around the central guide rod and adjacent to each other at the angle of 90.

4. The automatic dust debris clearing apparatus for the filter drum in the dust collector according to claim 1, wherein parts of the brush on the fixing base stretch to the inside of each of the curved grooves, parts of the brush stretch to the top of each of the curved grooves, and the brush of which the length is uneven crosses to reduce the frictional resistance to the dust clearing element that scrapes in the curved grooves.

5. The automatic dust debris clearing apparatus for the filter drum in the dust collector according to claim 1, wherein the drive connecting rod is bent at the angle of 90.

6. The automatic dust debris clearing apparatus for the filter drum in the dust collector according to claim 1, wherein the bottom of base joints a flexible rubber ringed seat made of a rubber, a fixing portion annularly protrudes in the center of the inner wall of rubber ringed seat, and a wedge slot is concave annularly in the center of the fixing portion and put around the base to separate the rubber ringed seat provided with an upper space and a lower space, in which the upper space may be wedged to the bottom of outer frame of the filter drum and the lower space may be put around a dust collection barrel.

7. The automatic dust debris clearing apparatus for the filter drum in the dust collector according to claim 1, wherein the drive element is provided with an axial rod passing through the center of top end of the filter drum and stretching to a position where a quadrangular rod is provided, and a quadrangular sleeve is provided at the top end of central guide rod to be put around the quadrangular rod.
